(19) United States
(12) Patent Application Publication
(10) Pub. No.: US 2013/0254893 A1
(43) Pub. Date: Sep. 26, 2013

(54) APPARATUS AND METHOD FOR REMOVING MALICIOUS CODE

(71) Applicant: Kyung Hee Kim, Bucheon-si (KR)

(72) Inventor: Kyung Hee Kim, Bucheon-si (KR)

(73) Assignee: AHNLAB, INC., Seongnam-si, Gyeonggi-do (KR)

(21) Appl. No.: 13/991,460

(22) PCT Filed: Dec. 7, 2011
(86) PCT No.: PCT/KR2011/009407

§ 371 Date: Jun. 4, 2013

(30) Foreign Application Priority Data
Dec. 7, 2010 (KR) 10-2010-0124087

(51) Int. Cl. G06F 21/56

(52) U.S. Cl. CPC G06F 21/56
USPC 726/24

(57) ABSTRACT

Disclosed are an apparatus and a method for removing a malicious code. Accordingly, the present invention provides a technology of mixing a cloud computing based network detecting scheme and a conventional malicious code detecting scheme for providing a detection engine to a client terminal according to a situation based on characteristics of the client terminal, helping efficiently cope with a malicious code.

### TECHNICAL FIELD

The present invention relates to an apparatus and a method for removing a malicious code. More particularly, the present invention relates to a technology relevant to a cloud computing based malicious code removing scheme.

### BACKGROUND ART

In recent years, as a high-speed internet environment has been constructed, damage due to malicious codes distributed through programs or e-mails is increasing.

Generally, a malicious code may lower a processing speed of a computer, fix an initial page of a web browser to an unhealthy site, cause a computer of a user to be used as a spam mail server or as a base PC for a DDoS(distributed denial of service) attack, and leak personal information of a user.

Malicious codes may be installed in a computer of a user to damage the computer though various routes such as ActiveX, Java Applet, Java WebStart, .NETClickOnce, Flash, and UCC, but most of them are installed when an original file is received from a web server using HTTP protocols.

Recently, studies on various defense mechanisms are being conducted to prevent distribution of such malicious codes.

Generally, an installed security program for preventing malicious codes refers to a program installed in a client terminal which detects a malicious code, a virus, or execution of an undesired file to remove the already infected client terminal, and includes a general vaccine program.

Meanwhile, malicious code prevention schemes based on cloud computing are recently appearing.

The malicious code prevention schemes based on cloud computing can promptly cope with new or mutant malicious codes because they detect and remove malicious codes of client terminals from a remote server based on a network.

Due to the advent of such various malicious code prevention schemes, it is required to study a method of efficiently preventing the spread of malicious codes by utilizing suitable malicious code prevention schemes according to a situation of a system.

### DISCLOSURE OF INVENTION

### Technical Problem

Therefore, the present invention has been made in view of the above-mentioned problems, and an aspect of the present invention provides a technology of mixing a cloud computing based network diagnosing scheme and a conventional malicious code detecting scheme for providing a detection engine to a client terminal according to a situation based on characteristics of the client terminal, helping efficiently cope with a malicious code.

### Solution to Problem

In accordance with an aspect of the present invention, there is provided a malicious code removing apparatus including: a determiner for determining whether a detection engine associated with detection and removal of a malicious code will be provided to a client terminal, or the malicious code will be detected and removed based on cloud computing, based on characteristics of the client terminal; a detection engine transmitter for, when the determiner determines that the detection engine will be provided to the client terminal, transmitting the detection engine to the client terminal; and an execution unit for, when the determiner determines that the malicious code will be detected and removed based on cloud computing, detecting and removing the malicious code based on cloud computing.

In accordance with another aspect of the present invention, there is provided a malicious code removing method including the steps of: determining whether a detection engine associated with detection and removal of a malicious code will be provided to a client terminal, or the malicious code will be detected and removed based on cloud computing, based on characteristics of the client terminal; transmitting, when it is determined that the detection engine will be provided to the client terminal; and detecting and removing, when it is determined that the malicious code will be detected and removed based on cloud computing.

### Advantageous Effects of Invention

Accordingly, the present invention provides a technology of mixing a cloud computing based network diagnosing scheme and a conventional malicious code detecting scheme for providing a detection engine to a client terminal according to a situation based on characteristics of the client terminal, helping efficiently cope with a malicious code.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a view illustrating a system for detecting and removing a malicious code according to an embodiment of the present invention;

FIG. 2 is a block diagram illustrating an malicious code removing apparatus according to an embodiment of the present invention; and

FIG. 3 is a flowchart illustrating a malicious code removing method according to an embodiment of the present invention.

### BEST MODE FOR CARRYING OUT THE INVENTION

The present invention may be variously modified and may have various embodiments, which will be illustrated in the attached drawings and described hereinbelow. However, it should be noted that the present invention is not limited to the specific embodiments, but include all changes, equivalents, and replacements within the spirit and technical scopes of the present invention. In a description of the drawings, the same or like reference numerals are used to designate the same or like elements.

It should be understood that when it is stated that a first element is “connected to” or “electrically connected to” a second element, it may be directly connected to or electrically connected to the second element but there may exist a third element therebetween. Meanwhile, it should be understood that when it is stated that a first element is “directly connected to” or “directly electrically connected to” a second element, there exists no third element therebetween.

The terms used herein are to explain only specific embodiments, and are not intended to limit the present invention. A singular expression covers a plural expression unless it is definitely used in a different way in the context. It should be understood that the terms “comprising”, “including”, and “having” use herein are intended to denote a feature, a number, a step, an operation, an element, a part, and a combination thereof described herein, but not to exclude one or more features, numbers, steps, operations, elements, parts, and combinations thereof.

Unless otherwise defined, the terms used herein including technical or scientific terms have the same meanings as those understood by those skilled in the art to which the present invention pertains. The terms generally defined in dictionaries should be construed to have meanings in agreement with those in the contexts of the related technology, and not construed as ideal or excessively formal meanings unless definitely defined herein.

Hereinafter, exemplary embodiments of the present invention will be described with reference to the accompanying drawings.

As malicious codes are increasing, system resources used by apparatuses to detect and remove the malicious codes cannot help but increase. Also, the amount of updated contents of a detection engine supplied from an update server to a client terminal to cope with a new or mutant malicious code is also increasing.

Recently, network detecting schemes based on cloud computing are appearing to reduce a load of a resource generated as an update server provides an update engine to a client terminal and promptly cope with a new or mutant malicious code.

Although the cloud computing based network detecting scheme can reduce a resource load of a client terminal and promptly cope with a new or mutant malicious code, it may be difficult to properly cope with a virus or a malicious code which requires a complex and continuous inspection.

Further, in the cloud computing based network detecting scheme, detecting speed may become slower when a detecting method of detecting various mutant malicious codes with one corresponding information element is applied to a network environment.

The cloud computing based network detecting scheme may not be utilized under an environment where network connection between a server and a client terminal is not always guaranteed.

Accordingly, the present invention provides a technology of mixing a cloud computing based network detecting scheme and a conventional malicious code detecting scheme for providing a detection engine to a client terminal according to a situation based on characteristics of the client terminal, helping efficiently cope with a malicious code.

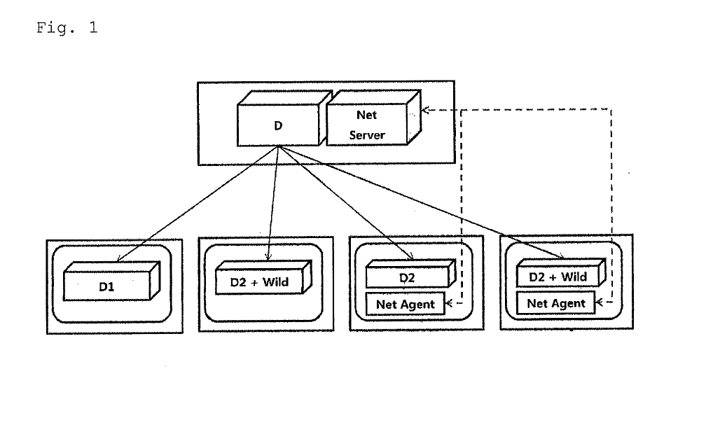

FIG. 1 is a view illustrating a system for detecting and removing a malicious code according to an embodiment of the present invention.

Referring to FIG. 1, a server apparatus 110 and at least one client terminal 121, 122, 123, and 124 are illustrated.

The server apparatus 110 includes management information D containing detection information and attribute information on various types applied to all malicious codes, and a service execution unit Net Server capable of detecting and removing a cloud computing based malicious code.

The server apparatus 110 determines whether, based on characteristics of the at least one client terminal 121, 122, 123, and 124, malicious codes will be detected and removed based on cloud computing for the client terminal 121, 122, 123, and 124 or a detecting engine for detecting and removing malicious codes will be provided to the client terminal 121, 122, 123, and 124.

For example, when a resource of the client terminal is sufficiently guaranteed and a network connection between the server apparatus 110 and the first client terminal 121 is not always guaranteed, the sever apparatus 110 may provide a detecting engine D1 for malicious codes to the first client terminal 121 using the management information D.

Then, the first client terminal 121 may detect and remove malicious codes after receiving the detection engine D1 from the server apparatus 110 and updating a preinstalled malicious code detecting program.

Meanwhile, when a resource of the third client terminal 123 is not enough to receive the detection engine D1 from the server apparatus 110 and a network connection between the server apparatus 110 and the third client terminal 123 is always guaranteed, the server apparatus 110 provides only a basic detection engine D2 which is a minimum engine for detecting and removing malicious codes to the third client terminal 123 and detects and removes malicious codes based on cloud computing using the service execution unit Net Server.

Then, malicious codes of the third client terminal 123 may be detected and removed based on cloud computing through the cloud execution unit Net Agent.

As a result, according to the embodiment of the present invention, the server apparatus 110 can determine whether a detection engine D1 will be provided to the at least one client terminal 121, 122, 123, and 124 according to characteristics of the client terminal 121, 122, 123, and 124 or malicious codes of the at least one client terminal 121, 122, 123, and 124 will be detected and removed based on cloud computing, enhancing malicious code detecting/removing efficiency.

The server apparatus 110 manages detection/removal histories of malicious codes and manages activity information on malicious codes which contains a predetermined number of detection/removal histories or more, creating an activity detecting engine Wild for the malicious codes containing a predetermined number of detection/removal histories or more based on the activity information.

In this case, the detection/removal histories for the malicious codes may be fed back from the at least one client terminal 121, 122, 123, and 124 to the server apparatus 110.

Then, the server apparatus 110 may determine whether the activity detecting engine Wild will be provided to the at least one client terminal 121, 122, 123, and 124 based on characteristics of the at least one client terminal 121, 122, 123, and 124.

For example, when the second client terminal 122 lacks resources to receive the detection engine D1 and a network connection between the second client terminal 122 and the server apparatus 110 is not always guaranteed, the server apparatus 110 may provide a basic detection engine D2 and the activity detection engine Wild to the second client terminal 122.

Then, the second client terminal 122 detects and removes malicious codes using the basic detection engine D2 and the activity detection engine Wild, properly coping with main malicious codes having a large number of detection/removal histories.

When the fourth client terminal 124 lacks the resources to receive the detection engine D1 and a network connection between the fourth client terminal 124 and the server apparatus 110 is always guaranteed, the server apparatus 110 may provide the basic detection engine D2 to the fourth client terminal 124, and detect and remove malicious codes based on cloud computing and provide the activity detection engine Wild.

Thus, malicious codes of the fourth client terminal 124 may be detected and removed based on cloud computing through the cloud execution unit Net Agent, and main malicious codes having a large number of detection/removal histories may be detected and removed using the activity detection engine Wild.

As a result, according to the embodiment of the present invention, the server apparatus 110 can determine whether the detection engine D1 will be provided to the at least one client terminal 121, 122, 123, and 124 according to characteristics of the at least one client terminal 121, 122, 123, and 124, malicious codes of the client terminal 121, 122, 123, and 124 will be detected and removed based on cloud computing, or the activity detection engine Wild will be provided to the at least one client terminal 121, 122, 123, and 124, making it possible to efficiently cope with the malicious code according to a situation.

Further, according to the embodiment of the present invention, a user of at least one client terminal 121, 122, 123, and 124 can select whether a detection engine D1 will be provided from the server apparatus 110, the malicious code will be detected or removed based on cloud computing, or an activity detection engine (Wild) will be provided.

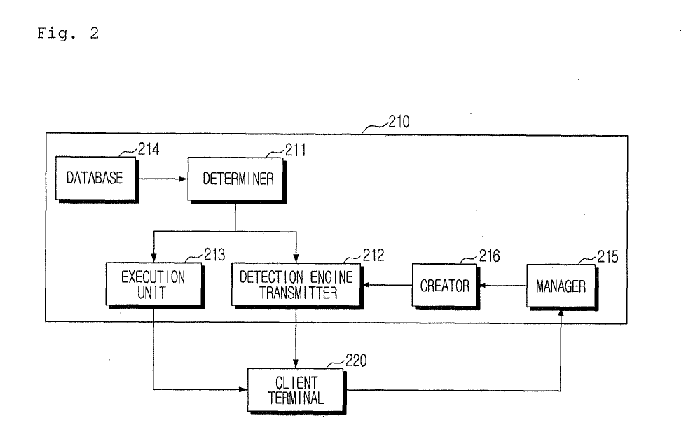

FIG. 2 is a block diagram illustrating a malicious code removing apparatus according to an embodiment of the present invention.

Referring to FIG. 2, the malicious code removing apparatus 210 includes a determiner 211, a detection engine transmitter 212, and an execution unit 213.

The determiner 211 determines whether a detection engine associated with detection and removal of a malicious code will be provided to a client terminal 220 based on characteristics of the client terminal 220 or the malicious code will be detected and removed based on cloud computing.

Then, according to the embodiment of the present invention, the malicious code removing apparatus 210 may further include a database 214.

The database 214 stores characteristic information associated with characteristics of the client terminal 220.

Then, the determiner 211 may determine whether the detection engine will be provided to the client terminal 220 from the database 214 with reference to the characteristic information, or the malicious code will be detected and removed based on cloud computing.

According to the embodiment of the present invention, the determiner 211 may determine whether the detection engine will be provided to the client terminal 220 based on a network connection between the malicious code removing apparatus 210 and the client terminal 220, or the malicious code will be detected and removed based on cloud computing.

Then, according to the embodiment of the present invention, when a network connection between the malicious code removing apparatus 210 and the client terminal 220 is always guaranteed, the determiner 211 may determine that the malicious code will be detected and removed based on cloud computing, and when a network connection between the malicious code removing apparatus 210 and the client terminal 220 is not always guaranteed, the determiner 211 may determine that the detection engine will be provided to the client terminal 220.

According to the present invention, the determiner 211 may determine whether the detection engine will be provided to the client terminal 220 based on a resource of the client terminal 220 or the malicious code will be detected and removed based on cloud computing.

When the determiner 211 determines to provide the detection engine to the client terminal 220, the detection engine transmitter 212 transmits the detection engine to the client terminal 220.

Then, when receiving the detection engine from the malicious code removing apparatus 210, the client terminal 220 may detect and remove the malicious code using the detection engine.

When the determiner 211 determines that the malicious code will be detected and removed based on cloud computing, the execution unit 213 may detect and remove the malicious code based on cloud computing.

Then, according to the embodiment of the present invention, the detection engine transmitter 212 may transmit a basic detection engine associated with driving of a malicious code detecting/removing process to the client terminal 220.

Then, if the client terminal 220 drives the malicious code detecting/removing process using the basic detection engine, the execution unit 213 may detect and remove the malicious code based on cloud computing.

According to the embodiment of the prevent invention, the malicious code removing apparatus 210 may further include a manager 215 and a creator 216.

The manager 215 manages detection/removal histories of malicious codes and manages activity information on a malicious code containing a predetermined number of detection/removal histories or more.

Then, the detection/removal histories of the malicious code may be fed back from the client terminal 220 to the manager 215, and the activity information may be managed by the manager 215 based on the dctcction/removal histories.

The creator 216 creates an activity detection engine including a detecting method for the malicious code containing a predetermined number of detection/removal histories or more based on the activity information.

Then, according to the embodiment of the present invention, the detection engine transmitter 212 may transmit the activity detection engine to the client terminal 220.

Then, the client terminal 220 may drive a malicious code detecting/removing process using the basic detection engine and detect and remove the malicious code containing a predetermined number of detection/removal histories or more using the activity detection engine.

Until now, the malicious code removing apparatus 210 according to the embodiment of the present invention has been described with reference to FIG. 2. Here, the malicious code removing apparatus 210 according to the embodiment of the present invention corresponds to the configuration of the server apparatus 110 which has been described with reference to FIG. 1, and a detailed description thereof will be omitted.

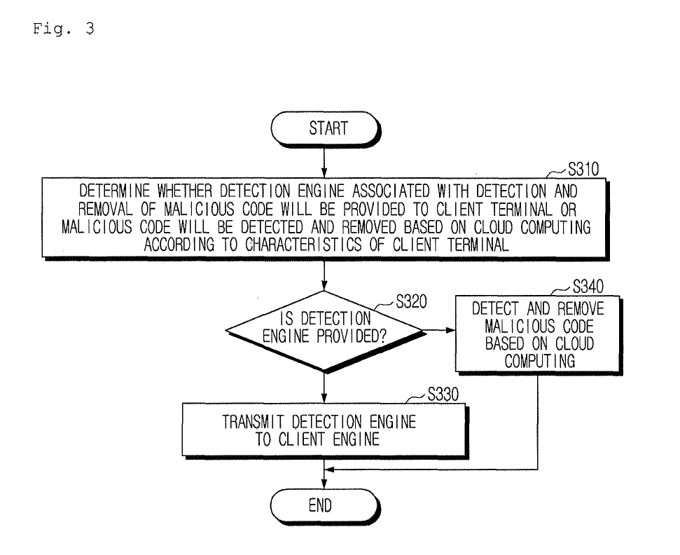

FIG. 3 is a flowchart illustrating a malicious code removing method according to an embodiment of the present invention.

In step S310, it is determined whether a detection engine associated with detection and removal of a malicious code will be provided to a client terminal based on characteristics of the client terminal or the malicious code will be detected and removed based on cloud computing.

Then, according to the embodiment of the present invention, the malicious code removing method may further include the step of managing a database where characteristic information associated with characteristics of the client terminal is stored before step S310.

Then, it may be determined whether the detection engine will be provided from the database to the client terminal or the malicious code will be detected and removed based on cloud computing with reference to the characteristic information.

If it is determined that the detection engine will be provided to the client terminal in step S320 after the determination of step S310, the detection engine is transmitted to the client terminal in step S330.

Then, when receiving the detection engine, the client terminal may detect and remove the malicious code using the detection engine.

However, if it is determined that the malicious code will be detected and removed based on cloud computing in step S320 after the determination of step S310, the malicious code may be detected and removed based on cloud computing in step S340.

According to the embodiment of the present invention, the malicious code removing method may further include the step of transmitting a basic detection engine associated with driving of the malicious code detecting/removing process to the client terminal before step S340.

Then, in step S340, if the client terminal drives the malicious code detecting/removing process using the basic detection engine, it may detect and remove the malicious code based on cloud computing.

Then, according to the embodiment of the present invention, the malicious code removing method may further include the step of managing detection/removal histories of malicious codes and managing activity information on the malicious code containing a predetermined number of detection/removal histories or more.

Thereafter, the malicious code removing method may further include the step of creating an activity detection engine including a detecting method for a malicious code containing a predetermined number of detection/removal histories or more based on the activity information.

Then, according to the embodiment of the present invention, the malicious code removing method may further include the step of transmitting the activity detection engine to the client terminal after step S340.

Then, the client terminal may drive the malicious code detecting/removing process using the basic detection engine, and may detect and remove the malicious code containing a predetermined number of detection/removal histories or more using the activity detection engine.

Until now, the malicious code removing method according to the embodiment of the present invention has been described with reference to FIG. 3. Here, the malicious code removing method according the embodiment of the present invention corresponds to the configuration of the malicious removing apparatus 210 which has been described with reference to FIG. 2, and a detailed description thereof will be omitted.

The malicious code removing method according to the embodiment of the present invention may be realized in the form of program instructions which can be implemented through various computer units, and may be recorded in a computer readable medium. The computer readable medium may include program instructions, data files, data structures, or combinations thereof. The program instructions recorded in the medium may be specifically designed and configured for the present invention or may be instructions well known to those skilled in computer software. Examples of computer readable recording media include hardware devices specifically configured to store and execute program instructions like a magnetic medium such as a hard disk, a floppy disk, and a magnetic tape, optical medium such as a CD-ROM and a DVD, a magneto-optical medium such as a floptical disk, a ROM, a RAM, and a flash memory. Examples of program instructions include machine language codes created by a compiler and high-level language codes executable by a computer using an interpreter as well. The hardware device may be configured to operate with at least one software module to perform an operation of the present invention, and vice versa.

Although the present invention has been illustrated and described through specific items such as detailed elements, the defined embodiments, and the drawings, they are only to help general understanding of the present invention and do not limit the present invention to the embodiments. Also, various changes and modification can be made from the description by those skilled in the art to which the present invention pertains.

Therefore, the spirit of the present invention is not limited to the above-described embodiments, and it should be construed that differences related to the modifications and variations in the elements are included within the scope of the present invention defined by the appended claims.

1. A malicious code removing apparatus comprising:
a determiner for determining whether a detection engine associated with detection and removal of a malicious code will be provided to a client terminal, or the malicious code will be detected and removed based on cloud computing, based on characteristics of the client terminal;
a detection engine transmitter for, when the determiner determines that the detection engine will be provided to the client terminal, transmitting the detection engine to the client terminal; and
an execution unit for, when the determiner determines that the malicious code will be detected and removed based on cloud computing, detecting and removing the malicious code based on cloud computing.

2. The malicious code removing apparatus as claimed in claim 1, further comprising a database where characteristic information associated with characteristics of the client terminal is stored, wherein the determiner determines whether the detection engine will be provided to the client terminal, or the malicious code will be detected and removed based on cloud computing, with reference to the characteristic information from the database.

3. The malicious code removing apparatus as claimed in claim 1, wherein when the detection engine is received from the malicious code removing apparatus, the client terminal detects and removes the malicious code using the detection engine.

4. The malicious code removing apparatus as claimed in claim 1, wherein the determiner determines whether the detection engine will be provided to the client terminal, or the malicious code will be detected and removed based on cloud computing, based on a network connection between the malicious code removing apparatus and the client terminal.

5. The malicious code removing apparatus as claimed in claim 4, wherein the determiner determines that the malicious code will be detected and removed based on cloud computing when a network connection between the malicious code removing apparatus and the client terminal is always guaranteed, and determines that the detection engine will be provided to the client terminal or the malicious code will be detected and removed based on cloud computing when a network connection between the malicious code removing apparatus and the client terminal is not always guaranteed.

6. The malicious code removing apparatus as claimed in claim 1, wherein the determiner determines whether the detection engine will be provided to the client terminal, or the malicious code will be detected and removed based on cloud computing, based on a resource of the client terminal.

7. The malicious code removing apparatus as claimed in claim 1, wherein the detection engine transmitter transmits a basic detection engine associated with driving of a malicious code detecting/removing process to the client terminal, and the execution unit detects and removes the malicious code based on cloud computing when the client terminal drives the malicious code detecting/removing process using the basic detection engine.

8. The malicious code removing apparatus as claimed in claim 7, further comprising:
a manager for managing detection/removal histories of malicious codes, and managing activity information on a malicious code containing a predetermined number of detection/removal histories or more; and
a creator for creating an activity detection engine including a detecting method for the malicious code containing the predetermined number of detection/removal histories or more.

9. The malicious code removing apparatus as claimed in claim 8, wherein the detection engine transmitter transmits the activity detection engine to the client terminal, and the client terminal drives the malicious detecting/removing process using the basic detection engine, and detects and removes the malicious code containing the predetermined number of detection/removal histories or more using the activity detection engine.

10. A malicious code removing method comprising the steps of:
determining whether a detection engine associated with detection and removal of a malicious code will be provided to a client terminal, or the malicious code will be detected and removed based on cloud computing, based on characteristics of the client terminal;
transmitting, when it is determined that the detection engine will be provided to the client terminal, the detection engine to the client terminal; and
detecting and removing, when it is determined that the malicious code will be detected and removed based on cloud computing, the malicious code based on cloud computing.

11. The malicious code removing method as claimed in claim 10, further comprising the step of managing a database where characteristic information associated with characteristics of the client terminal is stored, wherein it is determined whether the detection engine will be provided to the client terminal, or the malicious code will be detected and removed based on cloud computing, with reference to the characteristic information from the database, in the determination step.

12. The malicious code removing method as claimed in claim 10, wherein when the detection engine is received, the client terminal detects and removes the malicious code using the detection engine.

13. The malicious code removing method as claimed in claim 10, further comprising the step of transmitting a basic detection engine associated with driving of a malicious code detecting/removing process to the client terminal, wherein the malicious code is detected and removed based on cloud computing when the client terminal drives the malicious code detecting/removing process using the basic detection engine in the step of detecting and removing the malicious code.

14. The malicious code removing method as claimed in claim 13, further comprising the steps of:
managing detection/removal histories of malicious codes, and managing activity information on a malicious code containing a predetermined number of detection/removal histories or more; and
creating an activity detection engine including a detecting method for the malicious code containing the predetermined number of detection/removal histories or more based on the activity information.

15. The malicious code removing method as claimed in claim 14, further comprising transmitting the activity detection engine to the client terminal, wherein the client terminal drives the malicious detecting/removing process using the basic detection engine, and detects and removes the malicious code containing the predetermined number of detection/removal histories or more using the activity detection engine.

16. A non-transitory computer readable recording medium where a program for implementing a method as claimed in claim 10 is recorded.
